(19) United States
(12) Patent Application Publication
(10) Pub. No.: US 2004/0073542 A1
(43) Pub. Date: Apr. 15, 2004

(54) Database management system

(76) Inventors: Dean M Jones, Ipswich (GB); Zhan Cui, Colchester (GB)

Correspondence Address: Nixon & Vanderhye, 8th Floor, 1100 North Glebe Road, Arlington, VA, 22201-4714, US

(21) Appl. No.: 10/472,233

(22) PCT Filed: Mar. 15, 2002
(86) PCT No.: PCT/GB02/01265

(51) Int. Cl. G06F 17/30

(52) U.S. Cl. 707/3

(57) ABSTRACT

A database management systems is disclosed for solving distributed queries across a range of resources. In known systems, database retrieval from multiple sources suffers from problems of reconciliation of data between resources and resource or data incompatibility. The invention allows full database integration even in the case where a database includes a plurality of disparate database resources having differing ontologies (data structures). The system has a complex query analysis system that is arranged to find and link all database resources having the required elements for a specific database query. This then enables the query to be processed more efficiently.

The invention relates to a database management system, in particular such a system for solving distributed queries across a range of resources.

In known systems, database retrieval from multiple sources suffers from problems of reconciliation of data between resources and resource or data incompatibility.

Aspects of the invention are set out in the attached claims.

The invention provides various advantages. In one aspect, the invention allows full database integration even in the case where a database includes a plurality of disparate database resources having differing ontologies.

In another aspect, the invention allows an integrated solution by finding and linking all database resources having the required elements for a specific database query.

In yet a further aspect, the invention allows a structured and efficient approach to solving a query by identifying sub-queries and dealing with each sub-query in turn or in parallel for integrating the sub-query results.

Embodiments of the invention will now be described, by way of example, with reference to the drawings, of which:

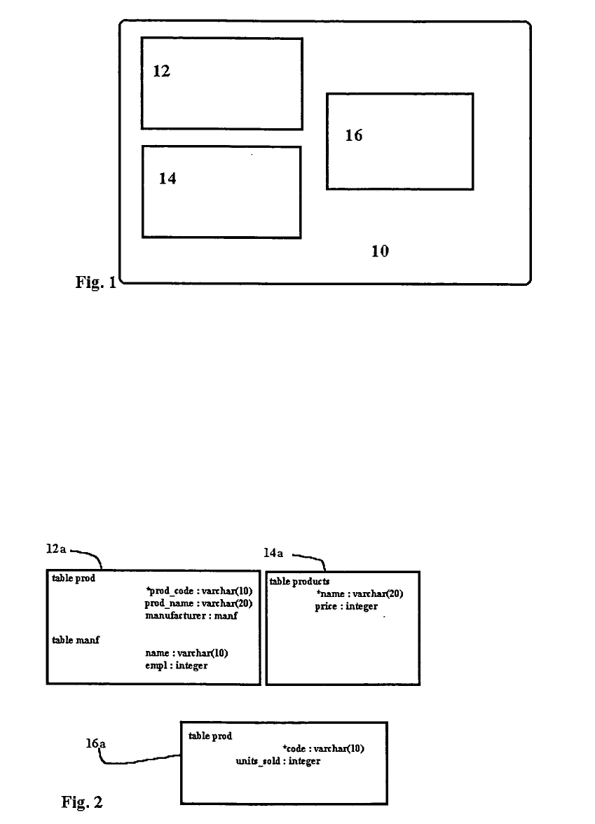

FIG. 1 is a block diagram of a network according to the present invention;

FIG. 2 is a block diagram of database resource schemas according to the present invention;

FIG. 3 is a block diagram of resource ontologies according to the present invention;

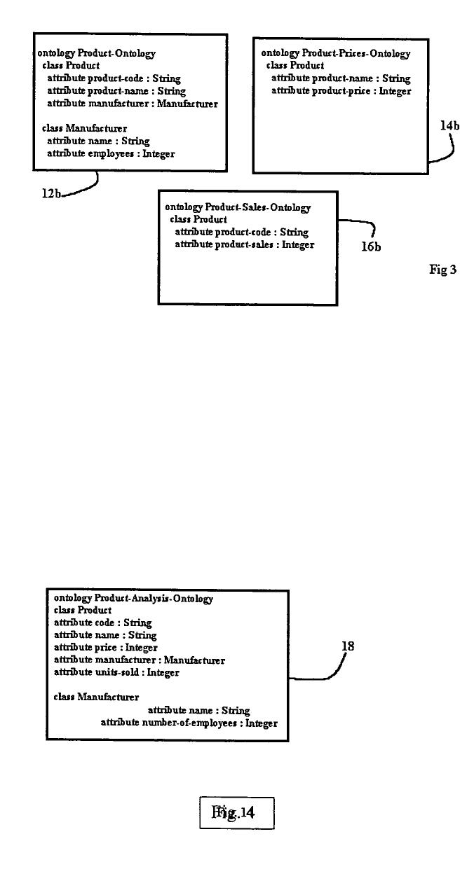

FIG. 4 is a block diagram of an application ontology according to the present invention;

FIG. 5 is a block diagram of a resource ontology-resource schema mapping according to the present invention;

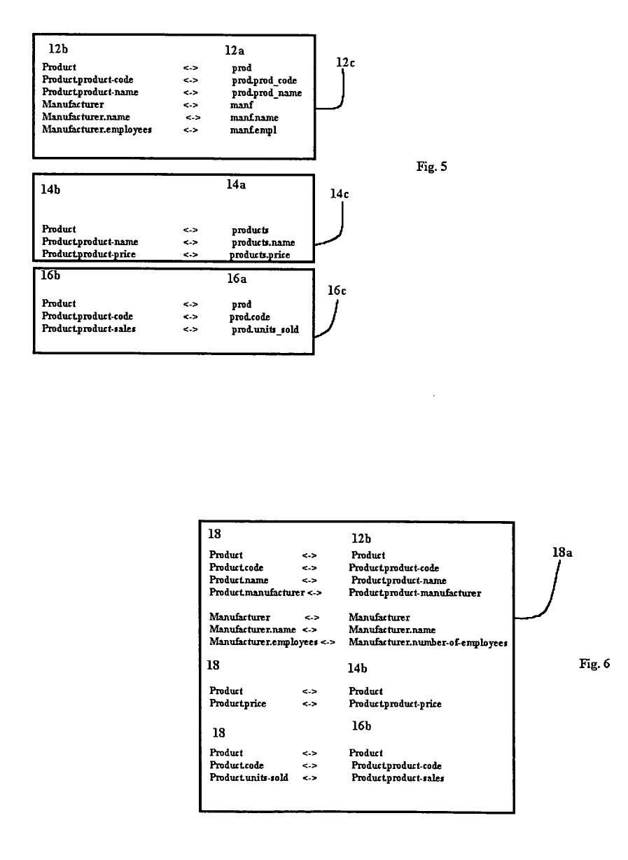

FIG. 6 is a block diagram of an application ontology-resource ontology mapping according to the present invention;

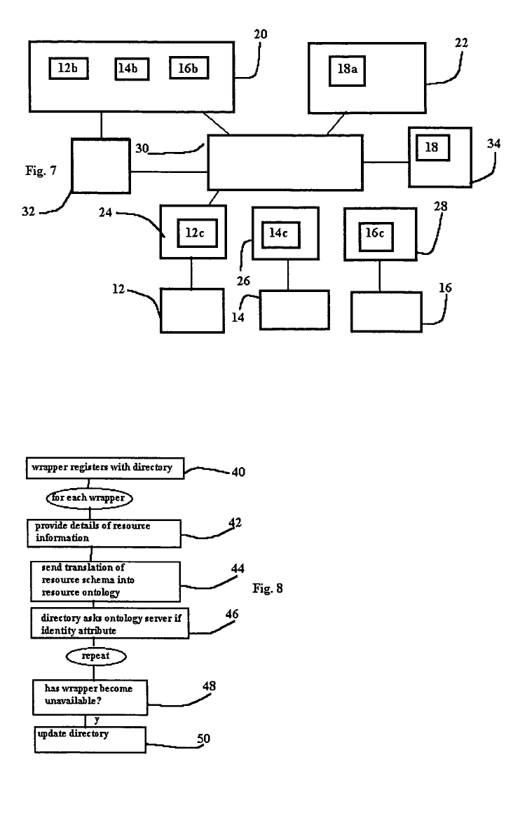

FIG. 7 is a further block diagram of a network according to the present invention;

FIG. 8 is a flow diagram showing an initialisation sequence according to the present invention;

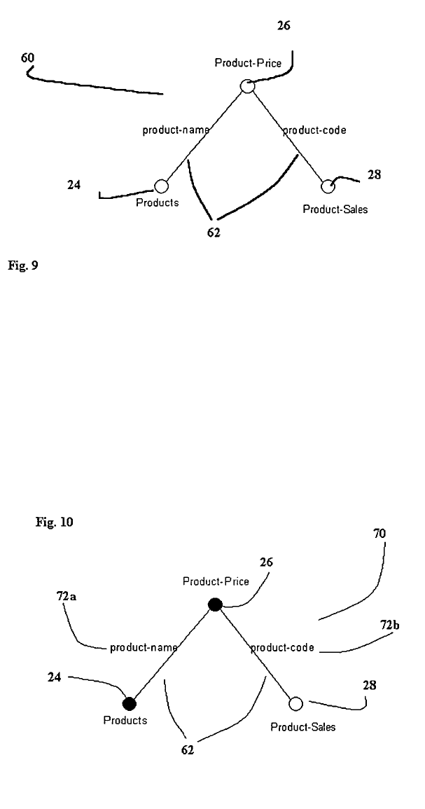

FIG. 9 is a node-arc representation of a concept identity graph according to the present invention;

FIG. 10 is a node-arc representation of a solution graph according to the present invention;

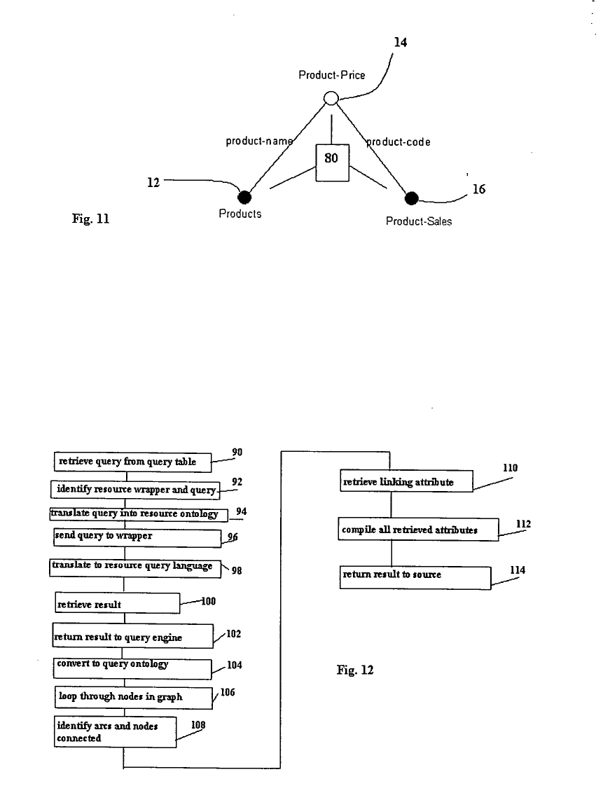

FIG. 11 is a node-arc diagram of an alternative solution graph according to the present invention; and

FIG. 12 is a flow diagram representing integration of data retrieved according to the present invention.

In overview, the invention provides a distributed query solution for a network having a plurality of database resources. In the preferred embodiment, the network used is a DOME network but it will be appreciated that any appropriate network can be used. The DOME network helps users to ask queries which retrieve and join data from more than one resource, such as an SQL or XML database.

When a query is received by the DOME query engine, it is treated as a request to retrieve values for a given set of attributes for all “individuals” that are instances of a given “concept” which also satisfy the given conditions. An “individual” is a specific field in a specific resource which may be duplicated, in another form, in another resource (e.g. in the specific example discussed below, two separate database resources may have fields, under differing names, for a common entity such as a product name). A “concept” is in effect the query strategy—the query concept may be to retrieve all relevant product names for products satisfying given criteria, in which case the individuals are the fields in the resources carrying that information. The attributes are then the values (e.g. product names) associated with the relevant fields or individuals. The query engine constructs a set of sub-queries to send to the relevant resources in order to solve the user's query. Before the sub-queries are sent, the query engine will translate them into the vocabulary or “ontology” of the relevant resource. After the sub-queries are translated into the query language of the relevant resource (e.g. SQL) the results are passed back to the query engine. Once the query engine has received the results to all sub-queries, it will integrate them and pass the final results to the user client.

The subsequent discussion uses as an example a network 10 having three database resources 12, 14, 16, as illustrated in FIG. 1 comprising a “products” database 12, a “product prices” database 14 and a “product sales” database 16. The starting point for a DOME network is this set of resources. Although in principal any resource containing structured data can be included, here we discuss only relational databases. Examples of SQL resource schema for each of the resources in our running example are given in FIG. 2, in which the schema for the products database is shown at 12a, for the product prices database at 14a and for the product sales database at 16a.

In setting up the network, first, a resource ontology is specified for each resource, which gives formal definitions of the terminology of each resource, ie database 12, 14, 16 connected to the network. Example resource ontologies are given in FIG. 3 for each of the products database 12b, products prices database 14b and product sales database 16b. If the ontology of a resource is not available, it is constructed in order to make the meaning of the vocabulary of the resource explicit. For a database, for example, the ontology will define the meaning of the vocabulary of the conceptual schema. This ontology ensures that commonality between the different resources and the originating query will be available by defining the type of variable represented by each attribute in the schema. In addition, as shown in FIG. 4, an application ontology 18 is defined, providing equivalent information for the attributes required for a specific, pre-defined application, in the present case an application entitled “Product Analysis”.

Having, by means of the ontology, effectively specified the data-type of each field or attribute in each of the distributed resources, a mapping is then specified between the resource ontology 12b, 14b, 16b and—in the case of a database—the resource schema 12a, 14a, 16a. This is shown in FIG. 5, for each of the products, product prices and product sales databases mappings 12c, 14c, 16c. Although it would be possible to define a mapping directly between an application ontology and the database schema, it is preferred to construct resource ontologies since the mapping between a resource ontology and a resource schema can then be utilised by different user groups using different application ontologies. This requires that relationships are also specified between an application ontology and a resource ontology before the query engine can utilise that resource in solving a query posed in that application ontology, as shown by mapping 18a in FIG. 6.

FIG. 7 shows the basic blocks of the network including the components described above. The resource ontologies 12b, 14b, 16b are stored in an ontology server 20, the resource ontology-application ontology mappings 18a are stored in a mapping server 22 and the resource schema-resource ontology mappings 12c, 14c, 16c are stored in the relevant wrapper 24, 26, 28, which is an intermediary between the query engine 30 and a resource 12, 14, 16. A wrapper is responsible for translating queries sent by the query engine to the query language of the resource. In addition the network includes a query table 31, wrapper directory 32 and block 34 for the application ontology 18 as discussed in more detail below.

Once the various elements of the network have been started, the initialisation sequence begins as shown in FIG. 8. At step 40 each of the wrappers 24, 26, 28 registers with the directory 32 and lets it know at step 42 about the kinds of information that its respective resource 12, 14, 16 stores. In order to describe the information that is available in a resource 12, 14, 16, a wrapper 24, 26, 28 needs to advertise the content of its associated resource with the directory 32. This is done in the terminology of the resource ontology 12b, 14b, 16b. This involves sending a translation into the resource ontology 12b, 14b, 16b of all possible parts of the resource schema 12a, 14a, 16a (i.e. those elements for which a resource ontology-resource schema mapping 12c, 14c, 16c has been defined.)

When the directory 32 receives an advertisement for an attribute of a resource 12, 14, 16, at step 46 it asks the ontology server if the role is an identity attribute for the concept (ie is the attribute listed in the application ontology 18) and the role is marked accordingly in the directory 32 database. Once each wrapper 24, 26, 28 has been initialised, the directory 32 is then aware of all resources 12, 14, 16 that are available and all of the information that they can provide. When a resource 12, 14 16 becomes unavailable (for whatever reason), at step 48 the wrapper 24, 26, 28 will communicate this to the directory 32 which updates at step 50 such that the information stored in the resource 24, 26, 28 will no longer be used by the query engine 30 in query solving.

A detailed description of the ontology translation techniques used in DOME is not necessary as the relevant approach will be well known or apparent to the skilled person. However an outline is provided that is sufficient for giving the detail of how a query plan is formed. In order to allow the translation of expressions from the vocabulary of one ontology to that of another, a set of correspondences are specified between the vocabularies of two ontologies. A correspondence between two concepts contains principally: the name of the source and target ontology and the source and target concept names. In some cases the correspondence also contains any pre- and post-conditions for the translation which are important for ensuring that the translation of an expression into the vocabulary of a target ontology has the same meaning as the original expression in the vocabulary of the source ontology. However this last aspect is not relevant to the present example.

The next step is to specify the elements that will be used when the query engine processes queries. In the preferred embodiment an object-oriented framework is used and so the methods associated with each element are also outlined.

A query that is passed to the query engine 30 has the following components: the ontology in which the terms used in the query are defined; a concept name; a set of names of attributes of the query concept for which values should be returned to the user client; a set of attribute conditions; and a set of role conditions. An attribute condition is a triple [symbol] an, op, val [symbol] where an is the name of an attribute of the query concept, op is an operator supported by the query language (e.g. ‘<’, ‘>’, ‘=’ and so on) and val is a permissible value for the given attribute or operator. In the specific example described herein are the names of the attributes in each of the conditions is relevant. Each of the role conditions is also a triple [symbol] rn, op, sq [symbol] where rn is the name of a role, op is an operator (e.g. ‘all’, ‘some’) and sq is a sub-query. The sub-query itself largely conforms to the above guidelines for queries but does not specify the name of the ontology, since this will be the same (it being a sub-set of the main query), or the names of attributes for which values should be returned, since these will be determined automatically. In the specific example discussed herein the operators in role conditions are not relevant.

In the specific example scenario, the user wants to find the name and code of all products which are made by companies with more than 100 employees and which have sold more than 10,000 units. We can represent this query more formally as:

(Product-Analysis-Ontology, Product,

{Product.product-name,Product.product-code}

{Product.product-sales}

{Product.manufacturer,(Manufacturer,{Manufacturer.emplo yees},{ })

where the application concept is “Product Analysis”, the attributes or individuals in the application are product name, code and sales and manufacturer employees and the resources are the product, product prices and product sales databases 12, 14, 16.

When describing the algorithms used in query processing, it is assumed objects exist that belong to the following classes (with associated methods):

Query—represents a query sent to the query engine

Query(c, o)—a constructor method which takes a concept name and an ontology name as arguments

getOntology( )—returns the name of the ontology in which the query is framed

getConcept( )—returns the name of the query concept

getRequiredAttributes( )—returns the set of required attributes

getAttributeConditions( )—returns the set of attribute conditions

getRoleConditions( )—returns the set of role conditions

addRequiredAttribute(a)—adds a to the set of required attributes

addAttributeCondition(ac)—adds ac to the set of attribute conditions

addRoleCondition(rc)—adds rc to the set of role conditions

RoleCondition

getRole( )—returns the role in the condition

getSubQuery( )—returns the condition's sub-query

setSubQuery( )—sets the value of the sub-query part (note that during processing, this can be set to the results to the sub-query)

AttributeCondition

getAttribute( )—returns the attribute in the condition

QueryEngine

askQuery(q)—the response to a query will be a table of values where each column corresponds to the values for an attribute and each row corresponds to the values for an individual

Directory

knows(c, o)—returns the set of wrappers that know about the concept c defined in ontology o

knows(a, c, o)—returns the set of wrappers that know about the attribute a of the concept c defined in ontology o

Wrapper

askQuery(q)—retrieve the results to the query q from the wrapper's associated resource

knows(c, o)—returns true if the wrapper knows about the concept c defined in the ontology o

knows(a, c, o)—returns true if the wrapper knows about the attribute a of the concept c defined in the ontology o

getPrimaryKey(c, o)—retrieve the key attribute(s) for concept c in ontology o

Accordingly commands are defined allowing operation of the query engine as discussed below.

When the query engine receives a query, a plan is constructed to solve the query given the available information resources and the algorithm for constructing such a plan is discussed below. Queries are solved recursively. The query engine first tries to solve each member of the set of sub-queries. Any of these that do not themselves have complex sub-queries can be solved directly (if the required information is available).

A number of different data structures are utilised in the following description. In order to keep the description as generic as possible, it is assumed that these data structures are implemented as objects, referring to the following objects and methods:

Graph—represents a graph consisting of a set of nodes and a set of arcs

addNode(n)—add node n to the graph

addArc(in, n, l)—add an arc between nodes n and m with the label l

reinoveNode(n)—remove the node n from the graph

connected( )—return true if the graph is connected

getNodes( )—returns the set of nodes

getSubGraphs( )—return the set of connected sub-graphs of the graph

Hashtable—a table of keys and associated values

put(k, v)—associate the key k with the value v in the table

get(k)—returns the value associated with the key k

hasKey(k)—returns true if the hashtable contains an entry with the key k

Accordingly the relevant structures are defined for subsequent processing of the query.

The next stage is to construct a “Concept Identity Graph” designated generally 60 as shown in FIG. 9, a directory and resources with wrappers having been established. The concept identity graph 60 represents, by linking them, the resources (ie databases 12, 14, 16) via the respective wrappers 24, 26, 28 that have the same primary key attribute (or attributes for composite keys) for a concept. Given some query q, a concept identity graph for the query concept defined in some ontology is constructed using the following algorithm, based on the commands and data structures discussed above:

Inputs: query—the query

Output: graph—the concept identity graph for query

initialise graph

o=query.getOntology( )

c=query.getConcept( )

wrappers[ ]=directory.knows(c, o)

for i=0 . . . |wrappers|−1

graph.addNode(wrappers[i])

primaryKey=wrappers[i].getPrimaryKey(c, o)

for j=0 . . . i−1

if primaryKey=wrappers[j].getPrimaryKey(c, o) then

g.addArc(w[i], w[j], primaryKey)

return g

In solving the top-level query in our example, the graph 60 in FIG. 9 is constructed. The wrappers related to resources having the relevant fields or attributes are identified and created as nodes. An arc 62 between nodes is created when the nodes so linked share a key attribute, ie, an attribute demanded by the query. Where there is an arc 62 between a pair of wrappers 24, 26, 28 in the graph 60, we can directly integrate information about the query concept that is retrieved from the resources 12, 14, 16 associated with those wrappers. In the example, information about products which is retrieved from the Product-Price resource 14 can be integrated with information about products retrieved from either the Products resource 12 or the Product-Sales resource 16, but information about products retrieved from the Products and Product-Sales resource cannot directly be integrated as there is no linking arc 62. For this reason, in order to ensure that information from two resources can be integrated, they must at least be in the same sub-graph of the concept identity graph 60, where a sub-graph may be the only graph or one set up to accommodate a sub-query forming part of an overall query (how information retrieved from two resources that are not neighbours in the concept identity graph may be integrated indirectly is discussed below).

The next stage is to construct queries to send to resources. The user query can be solved if it is ensured that:

(a) each condition and each user-specified required attribute is allocated to at least one resource query and

(b) the results to the resource queries can be integrated.

In other words, all the information required is available from one or other of the resources, and the resources are not themselves incompatible such the that information cannot be collated.

Starting with requirement (a), attribute conditions and required attributes can be allocated simply to resource queries by identifying resources that contain the relevant attributes. A slight complication is that, as outlined above, those resources must be in the same connected sub-graph of the concept identity graph 62, which is ensured by selecting one sub-graph at a time.

In the top-level query, the user specifies the attributes for which values should be returned. For sub-queries embedded in role conditions, this is not the case. There, the attributes for which values from the resource must be retrieved (e.g. for a query to an SQL database, which fields are named between ‘SELECT’ and ‘FROM’) must be determined. This is done by first finding a resource that answers the role condition and using this to determine the values that need to be retrieved. The system loops through the relevant resources until one can be found which allows the sub-query to be solved. The results to the sub-query are retrieved by issuing a query against the query engine (demonstrating again how queries are solved recursively) and the sub-query in the role condition is then replaced with these results.

The following algorithm demonstrates how required attributes and conditions are allocated to resource queries.

| | |
|---|---|
| Inputs: | q - the user query |
| | g - the concept identity graph for the query concept |
| Output: | resource QueryHashtable - mapping of wrappers to |
| | resource queries |
| | sub Graph - the component of the concept identity |
| | graph that enabled all parts of the query to be allocated |

subGraphs[ ] = g.getSubGraphs( )
o = q.getOntology( )
c = q.getConcept( )
requiredAttributes[ ] = q.getRequiredAttributes( )
attributeConditions[ ] = q.getAttributeConditions( )
roleConditions[ ] = q.getRoleConditions( )
allAllocated = false
for i = 0...|subGraphs|
subGraphNodes[ ] = subGraphs.getNodes( )
// allocate the user-specified required attributes
for j = 0...|requiredAttributes|−1

for k = 0...|subGraphNodes|−1
if subGraphNodes[k].knows(requiredAttributes[j], c, o) then
if resourceQueryHashtable.hasKey(subGraphNodes[k])

| | |
|---|---|
| resource Query | = |

resource QueryHashtable.get(subGraphNodes[k])

resourceQuery.addRequiredAttribute(requiredAttributes[j])

else
resourceQuery = new Query(c, o)
resourceQuery.addRequiredAttribute(requiredAttributes[j])
resourceQueryHashtable.put(subGraphNodes[k], resourceQuery)

// allocate the attribute conditions

for j = 0... |attributeConditions|−1

for k = 0 ... |subGraphNodes|−1

if subGraphNodes[k].knows(attributeConditions[j].getAttribute( ), c, o) then
if resourceQueryHashtable.hasKey(subGraphNodes[k])

| | |
|---|---|
| resourceQuery | = |

resourceQueryHashtable.get(subGraphNodes[k])

resourceQuery.addAttributeCondontion(attributeConditions[j])

else
resourceQuery = new Query(c, o)
resourceQuery.addAttributeCondition(attributeConditions[j])
resourceQueryHashtable.put(subGraphNodes[k], resourceQuery)

// allocate the role conditions
for j = 0...|roleConditions|−1
subQuery = roleConditions[j].getSubQuery( )
for k = 0...|subGraphNodes|−1
if subGraphNodes[k].knows(roleConditions[j].getRole( ), c, o) then

primaryKey = resources[k].getPrimaryKey(subQueryConcept, o)

subQuery.addRequiredAttribute(primaryKey)

subQueryResults = queryEngine.askQuery(subQuery)
roleConditions[j].setSubQuery(subQueryResults)

if resourceQueryHashtable.hasKey(subGraphNodes[k])

| | |
|---|---|
| resourceQuery | = |

resourceQueryHashtable.get(subGraphNodes[k])

resourceQuery.addRoleCondition(roleConditions[j])

else
resourceQuery = new Query(c, o)
resourceQuery.addRoleCondition(roleConditions[j])
resourceQueryHashtable.put(subGraphNodes[k], resourceQuery)

if allAllocated = true

return resourceQueryHashtable and subGraph[i]

Accordingly the algorithm allocates attributes, attribute conditions and role conditions by assessing the contents of the subgraph node resources. If some user-specified required attribute or condition cannot be allocated to a resource query, the user query cannot be solved by the current set of resources connected to the network and the user is informed.

Having shown how conditions and required attributes are allocated to resource queries, the next stage is ensuring that the results to these resource queries can be integrated. The connected sub-graph for which all of the required attributes and conditions can be allocated to a resource query is termed the solution graph 70 in FIG. 10. If some part of the user query has been allocated to a resource 12, 14, 16, we say that the resource is active in relation to a given query. The next stage is to ensure that it will be possible to integrate the results to each of the resource queries. In order to be able to integrate the results from two active resources (designated in the figure by the respective wrapper 24, 26, 28) which are neighbours in the solution graph 70, we need to retrieve values for an identity attribute 72a, b which labels the arc 62 joining the resources. It follows that if all of the active resources are neighbours in the solution graph 72, that is to say, they are linked by an arc 62 designating a shared attribute, provided we retrieve values for the correct attributes, we can integrate the results to all of the resource queries. For example, if there is a solution graph as shown in FIG. 10 with the active resources 24, 26 being shown as solid nodes, in order to integrate results to the two resource queries, it is necessary to retrieve the data for ‘product-name’ from each resource.

However, if an active resource does not have any active neighbours in the solution graph, it will not be possible to integrate the results from the corresponding resource query without some additional information. The solution adopted to this problem is to construct a set of one or more intermediate queries which are sent to the resources to retrieve data that is then used to integrate the results of the resource queries. An intermediate query 6b must be sent to each resource that lies on the path between (a) the active resource without any active neighbours, and (b) the nearest active resource to it. For example, consider the solution graph shown in FIG. 11. In order to integrate data from the active resources product and product sales 12, 16 represented by solid nodes an intermediate query 80 is sent to the ‘Product-Price’ resource 14 which retrieves information on the ‘product-name’ and the ‘product-code’ attributes. If we the ‘product-name’ data is retrieved from the ‘Products’ resource 12 and the ‘product-code’ data from the Product-Sales resource 16, the results can be used at the intermediate query 80 to integrate the result from the two resource queries. It may be that in order to make a path between two nodes that are active in a query, multiple intermediate queries are required dependent on the complexity of the query.

The algorithm to determine whether any intermediate queries are required is shown below and is based on determining whether the sub-graph that contains the active nodes is connected. If so, a solution has been found. If not, additional nodes are added until the graph is connected. Nodes are added by generating a combinations of inactive nodes, adding these to the graph and then determining whether the resulting graph is connected. Combinations of increasing length are generated i.e. if there are n inactive nodes in the graph, combinations are generated in order combinations of lengths 1 up to n. Combinations can be generated using an implementation of one of the many known algorithms generating combinations, for example Kurtzberg's Algorithm (Kurtzberg, J. (1962) “ACM Algorithm 94: Combination”, Communications of the ACM 5(6), 344).

This algorithm is implemented as below, taking the implementation as the function Combination(n, i) where n is the cardinality of the set of numbers to choose from and i is the length of the combinations to generate. This function returns a set of all possible combinations of length i.

| | |
|---|---|
| Inputs: | subGraph - the component of the concept identity graph that |
| | enabled all parts of the query to be allocated |
| | resourceHashtable - the mapping of wrappers to resource |
| | queries |

// determine which nodes are active
solution Graph = subGraph
solution Graph[ ] = sub Graph.getNodes( )
for i = 0...|subGraphNodes|−1
if not resourceGraph.hasKey(subGraphNodes[i])
inactiveNodes[ ].add(subGraphNodes[i])
subGraph.removeNode(subGraphNodes[i])
if not subGraph.connected( ) then
foundSolution = false
i = 0

while i <= |inactiveNodes| and not foundSolution

allCombinations[ ] = Combination(inactiveNodes, i)
for j = 0...|allCombinations|−1
combination[ ] = allCombinations[j]
for k = 0...|combination|−1
subGraph.addNode(combination[k])
// also need to add the arcs

add each resource in the combination as a node in the solution graph
add the required arcs to the solution graph

if(solutionGraph.isConnected

foundSolution := true;

else
remove nodes and arcs from the graph.

The final stage is to retrieve and integrate the data, and the system is illustrated with reference to FIGS. 7 and 12. In order to send the resource queries, at step 90 the system loops through the resourceQueryTable 31 and retrieves at step 92 each entry in turn, which will consist of the identity of a resource wrapper and the query to be sent to it. It is then necessary to translate each query into the ontology of the resource 12, 14, 16 (step 94) and send this version to the wrapper 24, 26, 28 (step 96). On receiving a query, at step 98 the wrapper 24, 26, 28 translates it into the query language of the resource 12, 14, 16 retrieves the results of the query (step 100) and sends these results back to the query engine 30 (step 102). Each of the individual results then needs to be converted into the ontology of the query at step 104 before they can be integrated to give the results of the query as a whole. Once results to all of the sub-queries have been received and converted to the query ontology at step 104, the integration of those results begins. At step 106 each unexplored node in a solution graph is looped through. At step 108, each arc on the node is identified and the attached node retrieved, and at step 110 the linking attribute is retrieved. Once this is completed, as the graph has been compiled to provide an integrated solution to the query, this technique will ensure that all attributes and attribute conditions are retrieved, in effect by replacing each node with the result retrieved by the wrapper. The query engine can then compile the attributes in the appropriate format at step 112 and return this result to the query source at step 114. An algorithm for dealing with this final step can be compiled in the manner adopted for the other stages discussed above.

It will be appreciated that variations of the system can be contemplated. Any number of resources of any database type or structure can be supported with the compilation of appropriate ontologies. Similarly any level of data or query structure, and network configuration or type can be used to implement the system, and the specific examples given in the description above are illustrative only.

1. A database management system comprising a database manager including a query engine and a plurality of database resources each containing database elements, in which the query engine is arranged to parse an incoming query to identify the elements required for a result, construct a node and link representation of database resources including as nodes resources containing the required element and as links elements common to individual nodes and compile an integrated result from the representation.

2. A system as claimed in claim 1 in which the query engine is arranged to compile the integrated result from the data stored as links in the representation.

3. A system as claimed in claim 1 or 2 in which the database: engine is arranged to create intermediate links between indirectly linked nodes via intermediate, commonly linked nodes.

4. A method of managing a database comprising a database manager including a query engine and a plurality of database resources each containing database elements comprising the steps of parsing an incoming query to identify the elements required for a result, constructing a node and link representation of database resources including as nodes resources containing the required element and as links elements common to individual nodes and compiling an integrated result from the representation.

5. A method as claimed in claim 4 further including the step of compiling the integrated result from the data stored as links in the representation.

6. A method as claimed in claim 4 or 5 further including the step of creating intermediate links between indirectly linked nodes via intermediate, commonly linked nodes.

7. A computer readable medium comprising instructions for implementing a system as claimed in any of claims 1 to 3 and/or a method as claimed in any of claims 4 to 6.
